(19) United States
(12) Patent Application Publication
(10) Pub. No.: US 2017/0247144 A1
(43) Pub. Date: Aug. 31, 2017

(54) Collapsible Container with Cover

(71) Applicant: Stuart Herskovitz, Dix Hills, NY (US)

(72) Inventor: Stuart Herskovitz, Dix Hills, NY (US)

(73) Assignee: Components.com, Inc.

(21) Appl. No.: 15/056,391

(22) Filed: Feb. 29, 2016

(51) Int. Cl. B65D 21/08; A61J 1/03; B65D 50/00; B65D 43/14

(52) U.S. Cl. CPC B65D 21/086; B65D 43/14; A61J 1/03; B65D 50/00

(57) ABSTRACT

A collapsible container includes: a container bottom; a container cap; a tubular member having a longitudinal axis and a cylindrical wall, the tubular member having an outer surface and an inner surface, the cylindrical wall having a wall thickness defined by the distance between the inner and outer surfaces, the cylindrical wall having first and second longitudinal zones of reduced thickness. The first and second longitudinal zones are substantially 180° apart such that the tubular member is collapsible along the first and second longitudinal zones to reduce the tubular member to a flattened state. The tubular member has a first end adapted to mate with the container bottom, and a second end adapted to selectably mate with the container cap. The container cap and container bottom are integrally formed with the tubular member and the container cap is configured to mate with the second end in a child-resistant manner.

### BACKGROUND OF THE INVENTION

1. Field of the Invention

The present invention is directed to collapsible containers, such as pill containers for dispensing of medicine.

2. Discussion of Related Art

Containers, such as pill containers, are known. A typical pill container has a rigid tubular shaped main body, with an integrally formed bottom surface and an opening at the top that may have, for example, structure formed at the upper edge configured to allow a separate cover or cap to be screwed or snapped onto the top of the rigid tubular main body.

A variation is shown in U.S. Pat. No. 5,180,072, which is incorporated herein by reference in its entirety, in which the rigid tubular body, with the integrally formed bottom, has an integrally formed cap that is attached to the tubular body by webs connecting a portion of the upper edge of the tubular body to a cap or closure. In this variation, the cap is provided with child-resistant structures that make it difficult for a child to obtain access to the contents of the container when the container is in the closed position.

A drawback of the container discussed above is that, due to the rigid structure of the tubular body, the containers take up a considerable amount of space, for example, if stored on shelf or in a drawer. Pharmacies, for example, must keep a large number of empty containers of this type on hand for dispensing medicine in the form of pills, capsules or cream. Because of the rigidity of the tubular body, much of the space required to store such containers actually consists of the empty space within the body of the tubular portion. This drawback is overcome by the present invention discussed below.

### SUMMARY OF THE INVENTION

The present invention solves the above-mentioned problems of the prior art by providing a collapsible container with a resilient tubular member, having inner and outer surfaces and a defined wall thickness, the wall of the tubular member having first and second longitudinal zones of reduced thickness allowing the tubular member to be collapsed into a flattened state for packaging and storage. Bottom and cap portions are, according to a preferred embodiment, attached to and integrally formed with the resilient tubular member, for example by injection or other molding techniques.

According to a first aspect of the present invention, a collapsible container includes: a container bottom; a container cap; a tubular member having a longitudinal axis and a cylindrical wall, the tubular member having an outer surface and an inner surface, the cylindrical wall having a wall thickness defined by the distance between the inner and outer surfaces, the cylindrical wall having first and second longitudinal zones of reduced thickness. The first and second longitudinal zones are substantially 180° apart such that the tubular member is collapsible along the first and second longitudinal zones to reduce the tubular member to a flattened state. The tubular member has a first end adapted to mate with the container bottom, and a second end adapted to selectably mate with the container cap. The container cap and container bottom are integrally formed with the tubular member and the container cap is configured to mate with the second end in a child-resistant manner.

In another aspect, the tubular member is connected to the container cap by an integrally formed cap web and the tubular member is connected to the container bottom by an integrally formed container bottom web.

In another aspect, the cap web and the container bottom web attach to the tubular member at opposite longitudinal ends of the tubular member.

In another aspect, the attachment of the cap web and the container bottom web at opposite longitudinal ends of the tubular member is effected substantially 180° apart from one another in a circumferential direction, and substantially 90° apart from the first and second longitudinal zones.

In another aspect, the tubular member is composed of a plastic material from the group consisting of polyethylene, polypropylene, polyvinylchloride and nylon.

In another aspect, the container cap, container bottom and tubular member are integrally formed in relation to one another by injection molding.

In another aspect, the container cap has ribs that cooperate with edge structures of the tubular member to effect child-resistant opening protection.

In another aspect, the first and second longitudinal zones have a reduced thickness of from 20 to 80% of the wall thickness.

In another aspect, the first and second longitudinal zones are about 50% of the thickness of the cylindrical wall thickness.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. In the drawings:

FIG. 1 is a perspective view of a collapsible container in accordance with one embodiment of the present invention;

FIG. 2 is a cross sectional view of the collapsible container of FIG. 1 taken along line 2-2 of FIG. 1;

FIG. 3 is a perspective view of the inventive collapsible container in a collapsed condition;

FIG. 4 is a cross sectional view taken along line 4-4 of FIG. 3;

FIG. 5 is a perspective view of the collapsible container with the bottom attached and the cap in an open state in accordance with one embodiment of the present invention; and

FIG. 6 is a side elevation with the cylindrical body, the cap, and the cap web in a partial cross-sectional view.

### DETAILED DESCRIPTION OF THE PRESENTLY PREFERRED EMBODIMENTS

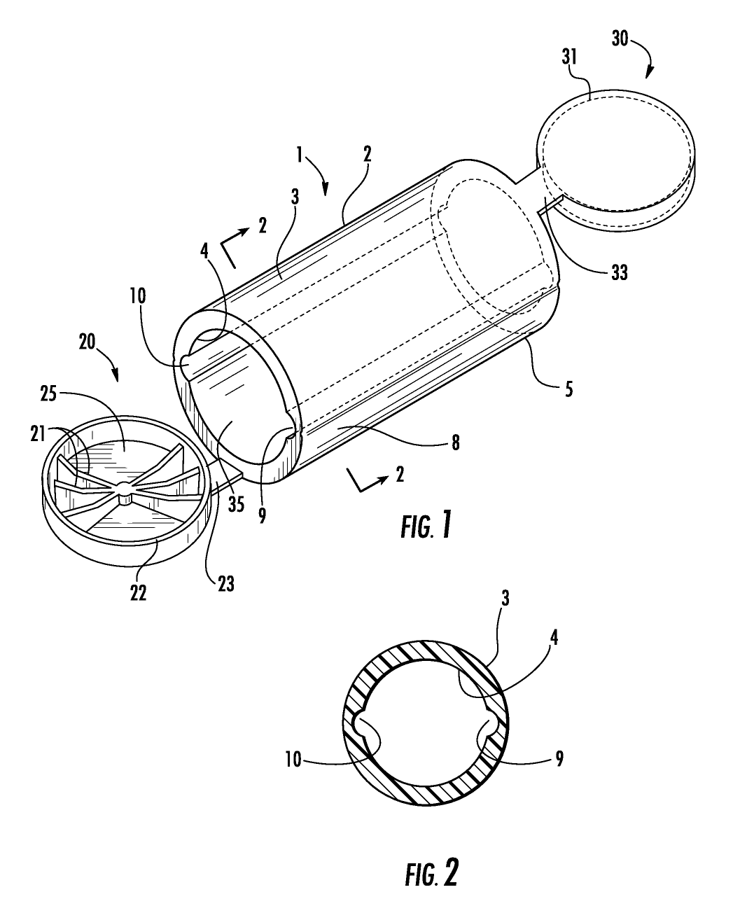

Referring to FIG. 1, a collapsible container 1 has a cylindrical body 2 with an outer surface 3 and an inner surface 4 and defining an inner space 35. The body has a wall thickness defined by the distance between the inner and outer surfaces. The body 2 has a first end 5, or bottom, which is adapted to be sealingly closed by a bottom cover 30, shown partially in FIG. 1.

Preferably, the first end 5 fits snugly within the bottom cover 30 to provide an airtight fit, for sealing the bottom, for example, of a pill container. To maintain a tight fit, it is advantageous to assure that there is sufficient overlap between the walls 31 of the bottom cover 30 and first end 5 to provide an interference fit for retaining the body 2 in a cylindrical shape substantially across its length. When the bottom cover 30 is so affixed, rigidity is provided to the body 2.

Alternatively, the cap can go inside the bottom, or a channel can be formed to receive the edges of end 5.

Preferably, as a result of forming the body 2 and the bottom cover 30 integrally, for example by molding, the first end 5 is connected to the bottom cover 30 by a bottom cover web 33. This web 33 serves to connect the body 2 to the bottom cover 30 to allow for storage of the body 2, typically in a flattened state, and the bottom cover 30 without having the pieces separate.

The cylindrical body 2 has a cap end 8, configured to, in an un-collapsed state of the cylindrical body 2, sealingly engage the walls 22 of the cap 20. Preferably, the cap 20 has internal structures 21 that allow for a child-proof attachment of the cap 20 to the cylindrical body 2, for example by preventing opening of the cap 20 until certain portions of the edge of the cap 20 are squeezed simultaneously. As will be described in more detail below, the upper edge of the cylindrical body 2 has corresponding structure to provide child-proofing structure for the cap 20, in a closed state.

As a result of forming the body 2 and the cap 20 integrally, for example by molding, the cap end 8 is connected to the cap 20 by a cap web 22. This web 22 serves to connect the body 2 to the cap 20 and allows for storage of the body 2 and the cap 20, as well as the integrally connected bottom cover 30, without having the pieces separate.

Preferably, the tube 2, the cap 20 and the bottom end 30 are each formed of a plastic material such as polyethylene, polypropylene, nylon, polyvinylchloride or other material suitable for use in a molding process. Some composite materials such as a fiberboard/plastic hybrid material may also be used with the present invention.

The cylindrical body 2 has a pair of longitudinal grooves 9 and 10 located at approximately 180° apart. These grooves extend along substantially the entire length of the interior surface of the cylindrical body 2. Preferably, the grooves extend into the wall thickness of the cylindrical body from 10-80% and preferably from 30-65%. Such an extension into the wall thickness assures that the collapsible container may collapse into a flattened form across these weakening structures i.e., the grooves in the side wall, such that the collapsible container may be packaged in substantially flat form.

Referring to FIG. 2, a cross sectional view of the cylindrical body 2 of FIG. 1 is shown in an expanded state with the grooves entering approximately 50% of the wall thickness. For example, a cylindrical body 2 having an outer diameter of approximately 1″ and an inner diameter of approximately ¾″ has a wall thickness of ⅛″. The grooves 9 and 10 preferably have a hemispherical shape and at a center axis of the hemispherical grooves, the depth is about ⅛″. Each groove has a width at the inner tube surface of about 3/16″. While such hemispherical grooves are shown, it will be understood that square or triangular grooves could additionally be used and the shape of the grooves is unimportant so long as a pair of weakening zones are created on opposite sides of the mouthpiece, preferably at 180° to each other, such that the cylindrical tube 2 is collapsible into a flat form.

Utilizing the inventive collapsible container, individual packaging in flat form is facilitated.

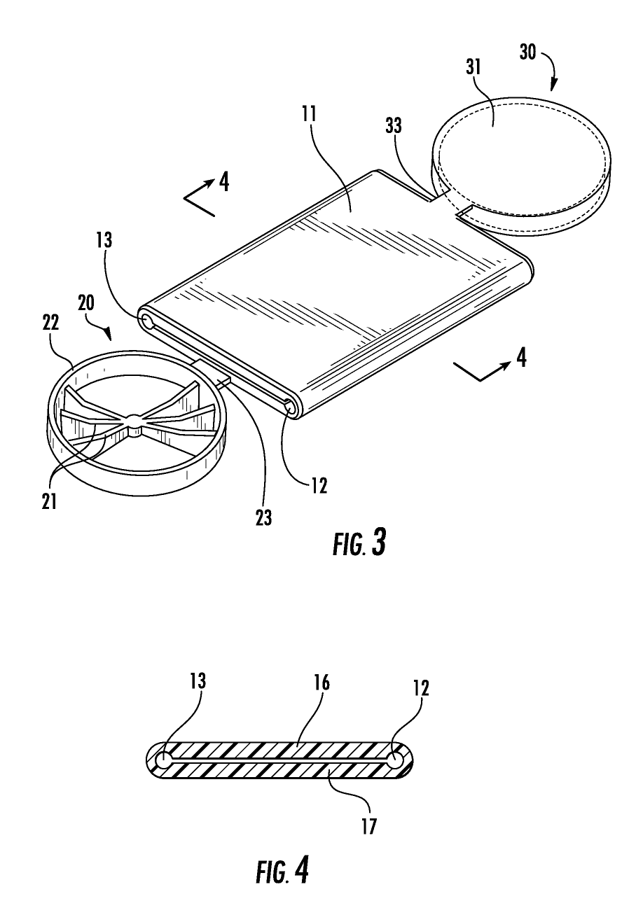

FIG. 3 illustrated the collapsible container 1 in its collapsed form, in which it is suitable for storage. As shown in the figure, a pair of grooves 12 and 13. The addition of packing, such as shrink wrap to maintain the flattened profile (not shown), allows a plurality of individually packaged collapsible containers to be placed in a box with minimum open space. Additionally, for disposal, the container is easily compressed during disposal into its flat form to minimize the volume it occupies during disposal.

FIG. 4, shows a cross-section taken along the lines 4-4 from FIG. 3. In compressed tube 11, the grooves, being weakening structures, adapt by relieving the compressive force and allowing the tube to collapse into a pair of substantially parallel walls, 16 and 17.

Utilizing the inventive collapsible container simplifies packaging for efficient storage utilization.

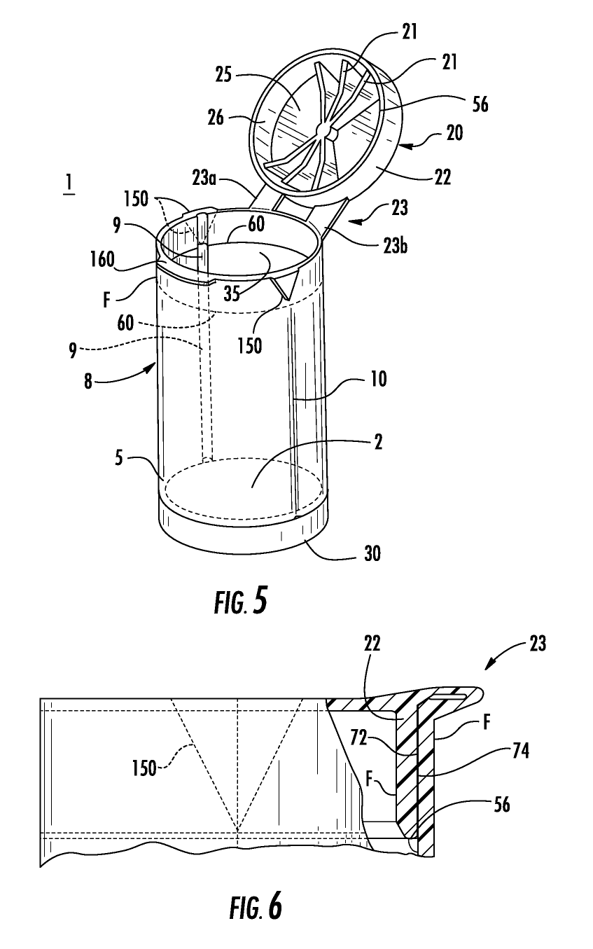

The cap 20 may be formed as child-resistant in a number of different ways. The only constraint that the child-proofing technique does not involve the necessity of a twisting technique. For example, as shown in FIG. 5, a known safety cap of the type shown in U.S. Pat. No. 5,180,072, the contents of which are incorporated herein by reference, can be advantageously used to form the cap 20 of the collapsible container 1.

As shown in FIG. 5, the web 23 is formed of two web sub-portions 23a and 23b. The cap, covers the opening 18 and has a downwardly protruding cap wall 22. Side wall 2 and the cap wall 22 define a pair of flexors F. In the system 10 of FIG. 5, the side wall 2 defines an outer flexor disposed outwardly of an inner flexor, which is the cap wall 22.

A latch 56 protrudes from the lower outer side of the cap wall 22 and is at least partly receivable in a catch or circular recess on the inner side of the side wall 2 for cooperatively interlocking for normally holding the cap 20 onto the container 1.

In FIG. 6, the flexors F each have thereon an inclined surface, 72 or 74. A frustro-conical first inclined surface 74 facing outward is on the cap wall 22 with its lesser diametered portion at its inner or bottom end, a frustro-conical second inclined surface 72, facing inward, with its lesser diametered portion at its top or outer end on the inner side of the side wall 24. The inclined surfaces 72 and 74 are so cooperatively shaped that when sufficient pressure is applied to two opposite sides, such as the right and left sides of the outer flexor, which is the side wall 2, latch 56 will be forced out of the catch 60 accomplishing opening of container 1.

The required pressure for a medicine vial is the amount of pressure that an average adult person with average strength, or any normal adult person, is capable of applying by the pinching of the outer flexor, which is the container 1 on opposite sides. In the embodiment of FIG. 5, the right side and left side are compressed between the thumb and a finger of the same hand.

The web 23 forms a hinge that is provided on the container 1, which interconnects container 1 with the cap 20 rear side 25. The web 23, consisting of web portions 23a and 23b, serves to limit the flexing of the flexors F when pinching pressure is applied by a child on the hinged rear side of the tube 2, and on the opposite or front side of the tube 2.

As discussed above, the web 23 is formed as one piece with the tube 2, the cap 20 and the bottom end 30 and associated web 33 for a rapid injection molding, as discussed above.

Returning to FIG. 5, the cap 20 has a central portion 25 substantially surrounded by the cap wall 22, having an inner surface 26. An optional elongated rib assembly 21 on the underside of the central portion 25 is of one piece with the central portion 25 and causes the cap 20 to be thicker and stiffer along the rib assembly 21.

The rib assembly 21 is seen to be elongated in a direction approximately extending from adjacent the cap wall 22 on the hinged rearward portion of the cap wall and toward the front side of the cap 20. The rib assembly 21 has rearward ribs and forward ribs, each spaced from the cap wall 22 to avoid a holding-in of the cap wall 22 at the ends of the rib assembly 21. This allows for free bending-out of the cap wall at the hinged backside and at the front side for ease of adult opening.

The ribs 21 are close enough to the cap wall 22 to substantially block latch-and-catch-unlocking inward movement of the cap wall 22 at the back and front sides of the tube 2 at the cap-side opening so as to deter a child from opening it and accessing the contents.

The flexors F are sufficiently flexible and so-shaped that a force can be applied by substantially any normal adults, against the system 10 sufficiently for assisting the adult to gain access to the cavity 35. The force applied is a pinching of the side wall 24 on its left and right sides about one quarter inch from the top of the tube 2 and at the level of the cap wall 22.

The entire cap 20 is disposed substantially within the outlines of the tube 2 to increase difficulty of gripping the cap 20 and for child safety.

Opening is accomplished by pinching the flexors of the tube 2 between the thumb and a finger of the same hand causing the latch 56 to be forced out of the catch 60 for an unlocking.

The inward-bending of the outer flexor F is at a point below the upper end of the tube 2 and sufficient force of pinching on the right and left sides of the container at such a position can cause a closure to be expelled. However the amount of force that a small child can apply in such positions is not sufficient to cause opening.

It has been found that if the child squeezes the cap 20, it is usually with a full hand force on all sides, not a pinch, and opening does not occur.

Distractors 150 formed at the cap side opening of the tube 2 also serve as indicators to an adult of where to push and so are made in downwardly pointed triangular arrowhead shape. Horizontally protruding distraction lip 160, which cannot effect opening, is attached to the forward side of the container 1.

While preferred embodiments of the present invention have been shown and described, it will be understood by those skilled in the art that various changes and modifications could be made without varying from the scope of the present invention.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A collapsible container comprising:
a container bottom;
a container cap;
a tubular member having a longitudinal axis and a cylindrical wall, the tubular member having an outer surface and an inner surface, the cylindrical wall having a wall thickness defined by the distance between the inner and outer surfaces, said cylindrical wall having first and second longitudinal zones of reduced thickness,
said first and second longitudinal zones being substantially 180° apart such that the tubular member is collapsible along the first and second longitudinal zones to reduce the tubular member to a flattened state, the tubular member having a first end adapted to mate with the container bottom, and a second end adapted to selectably mate with the container cap,
wherein the container cap and container bottom are integrally formed with the tubular member and wherein the container cap is configured to mate with the second end in a child-resistant manner.

2. The collapsible container according to claim 1, wherein the tubular member is connected to the container cap by an integrally formed cap web and the tubular member is connected to the container bottom by an integrally formed container bottom web.

3. The collapsible container according to claim 2, wherein the cap web and the container bottom web attach to the tubular member at opposite longitudinal ends of the tubular member.

4. The collapsible container according to claim 3, wherein the attachment of the cap web and the container bottom web at opposite longitudinal ends of the tubular member is effected substantially 180° apart from one another in a circumferential direction, and substantially 90° apart from the first and second longitudinal zones.

5. The collapsible container according to claim 1, wherein the tubular member is composed of a plastic material from the group consisting of polyethylene, polypropylene, polyvinylchloride and nylon.

6. The collapsible container according to claim 2, wherein the container cap, container bottom and tubular member are integrally formed in relation to one another by injection molding.

7. The collapsible container according to claim 1, wherein the container cap has ribs that cooperate with edge structures of the tubular member to effect child-resistant opening protection.

8. The collapsible container according to claim 1, wherein the first and second longitudinal zones have a reduced thickness of from 20 to 80% of the wall thickness.

9. The collapsible container according to claim 1, wherein the first and second longitudinal zones are about 50% of the thickness of the cylindrical wall thickness.
